(19) United States
(12) Patent Application Publication
(10) Pub. No.: US 2016/0294505 A1
(43) Pub. Date: Oct. 6, 2016

(54) DATA RATE ADAPTATION IN A WIRELESS TRANSMITTER

(71) Applicant: QUALCOMM TECHNOLOGIES International, Ltd., Cambridge (GB)

(72) Inventors: Richard TURNER, Cambridge (GB); Simon CLARKE, Cambridge (GB); Laurent WOJCIESZAK, Cambridge (GB); Matthew GIBSON, Cambridge (GB)

(21) Appl. No.: 14/688,803

(22) Filed: Apr. 16, 2015

(30) Foreign Application Priority Data
Mar. 31, 2015 (GB) GB1505596.5

(51) Int. Cl. H04L 1/00

(52) U.S. Cl. CPC H04L 1/0002; H04L 1/0019; H04L 1/0033

(57) ABSTRACT

The present application relates to methods for adapting a data rate used to generate data packets for transmission by a wireless transmitter (12) operating in a wireless network. In one method, the transmitter (12) monitors the number of data packets that cannot be transmitted in a given time period, and adjusts the data rate used for generation of data packets for transmission in accordance with the number of packets that remain un-transmitted at the end of the given time period. In another method, the transmitter (12) uses information associated with or derived from Acknowledgements received from a receiving device to determine whether an adjustment to the data rate used for generation of data packets for transmission is required. In a further method, the transmitter (12) monitors a packet error rate for transmitted packets and determines a maximum packet error rate that can be supported by the wireless network without instability.

### CROSS-REFERENCE TO RELATED APPLICATIONS

This application claims priority to United Kingdom patent application Serial No. GB1505596.5, filed Mar. 31, 2015, which is incorporated herein by reference in its entirety.

### TECHNICAL FIELD

The present invention relates to methods for data rate adaptation in a wireless transmitter.

### BACKGROUND TO THE INVENTION

Most wireless home networks are based on the IEEE802.11 set of standards, and are commonly known as WiFi® networks. Such networks comprise a number of transmitting devices which communicate with each other via a wireless router or access point (AP).

A WiFi® network has limited bandwidth for data transfer between connected devices. When the network reaches maximum utilisation, the network suffers from bandwidth limitation problems which can lead to network degradation in the form of increased latency and loss of data. The network may also become unstable as more data is transferred over it, which can lead to sharp reductions in network bandwidth.

This problem is particularly pronounced in networks where there is more than one source node transmitting data on the network, for example where a media source node generates media to be streamed to multiple devices on the network via an access point, or where two or more access points (serving different networks) are in close proximity to one another. In the latter case the first and second access points may be physically far enough apart not to affect one another directly, but the first access point can cause disruption and non-receipt of packets by nodes or devices of the network served by the second access point (and vice versa) due to packet collision.

Typically an access point will select its modulation and coding scheme (MCS) based on a number of factors. One of the main metrics used by the access point in selecting its MCS, and one of the easiest to measure, is Packet Error Rate (PER). PER is a measure of the number of incorrectly received data packets divided by the total number of received data packets. A high PER may arise due to a number of conditions, including large path loss (i.e. a weak signal due to a large distance between the AP and a receiving device), multipath fading, or traffic collision. These different conditions all give rise to similar symptoms, namely no receipt of Acknowledgements for received packets (as the packets are not received), but the remedial action required to correct high PER resulting from path loss or multipath fading is different from the remedial action required to correct high PER resulting from traffic collision.

Because high PER can have more than one cause, it can be difficult for an access point to select the correct remedial action to maintain overall network bandwidth. For example, one way to reduce the PER resulting from large path loss is to reduce the transmission rate, as lower transmission rates give better wireless range than higher transmission rates. However, at lower transmission rates packets take longer to transmit, and have a higher probability of colliding with packets transmitted by other access points, and overall network bandwidth is reduced.

In some circumstances increased PER can lead to severe fluctuations in the transmission rate of an access point and the receive rate of a receiving device, which in turn leads to severe fluctuations in the available network bandwidth, with sharp drops (referred to by the inventors as “pinching”) in the available bandwidth. This pinching can result in increased latency in the network.

Accordingly, a need exists in the art for improvements in the way in which changing network conditions are handled by wireless transmitters operating in wireless networks such as WiFi® networks, to optimise data transmission rates for prevailing network conditions.

### SUMMARY OF INVENTION

The present application relates to methods for adapting a data rate used to generate data packets for transmission by a wireless transmitter operating in a wireless network.

In one method, the transmitter monitors the number of data packets that cannot be transmitted in a given time period, and adjusts the data rate used for generation of data packets for transmission in accordance with the number of packets that remain un-transmitted at the end of the given time period.

In another method, the transmitter uses information associated with or derived from Acknowledgements received from a receiving device to determine whether an adjustment to the data rate used for generation of data packets for transmission is required.

In a further method, the transmitter monitors a packet error rate for transmitted packets and determines a maximum packet error rate that can be supported by the wireless network without instability, and a maximum data rate for generating data packets for transmission by the transmitter.

The disclosed methods permit the transmitter to adapt rapidly to changing conditions within a wireless network environment and reduce the risk of bandwidth pinching and high latency arising from changes in the wireless network environment.

According to a first aspect of the present invention there is provided a method for data rate adaptation in a wireless transmitter, the method comprising: generating a plurality of data packets for transmission by the wireless transmitter; defining a time window within which a predetermined number of the generated data packets are to be transmitted; commencing transmission of the generated data packets; at the end of the time window, measuring how many of the predetermined number of the generated data packets have not been transmitted; and adjusting a data rate at which data packets for transmission are generated based on the measured number of un-transmitted data packets.

The generated data packets may be stored in a transmission queue.

The number of un-transmitted packets remaining in the transmission queue may be measured at the end of the time window.

Adjusting the data rate at which data packets for transmission are generated based on the measured number of un-transmitted packets may comprise comparing the number of un-transmitted packets to a threshold and reducing the data rate if the measured number of un-transmitted packets meets the threshold.

Adjusting the data rate at which data packets are generated for transmission based on the measured number of un-transmitted packets may comprise comparing the number of un-transmitted packets to a plurality of different thresholds and reducing the data rate according to a threshold of the plurality of thresholds that is met by the number of un-transmitted packets.

According to a second aspect of the invention there is provided a method for data rate adaptation in a wireless transmitter, the method comprising: generating a plurality of data packets for transmission by the wireless transmitter; transmitting each of the plurality of data packets in turn; receiving at the wireless transmitter an application layer acknowledgement from a receiving device that a data packet has been received; and based on information associated with the application layer acknowledgement, adjusting the data rate at which data packets are generated for transmission by the wireless transmitter.

The method may further comprise: storing each transmitted data packet in an application level acknowledge queue at the wireless transmitter; and removing a transmitted data packet from the application level acknowledge queue when an application layer acknowledgement of that data packet has been received by the wireless transmitter from a receiving device.

The method may further comprise: measuring a difference between an expected time of receipt by the wireless transmitter of an application layer acknowledgement for a particular transmitted data packet and an actual time of receipt of the application layer acknowledgement for the particular transmitted data packet; and based on the measured difference between the expected time of receipt and the actual time of receipt, adjusting the data rate for generation of data packets for transmission by the wireless transmitter.

The information associated with the application layer acknowledgement may comprise an indication of the proportion of the data packets received by the receiving device that were re-transmissions at the MAC layer of data packets that were previously not successfully received by the receiving device.

The information associated with the application layer acknowledgement may comprise one or more of: the mean transmission rate; the median transmission rate; and the peak transmission rate of the transmitter or the receiving device.

The information associated with the application layer acknowledgement may comprise an indication from the receiving device of the number of corrupted packets received by the receiving device.

The information associated with the application layer acknowledgement may comprise an indication of network occupancy.

The method may further comprise: receiving additional network related information from the receiving device; and based on the information associated with the application layer acknowledgement and the additional network related information, adjusting the data rate at which data packets are generated for transmission by the wireless transmitter.

The additional network related information may comprise a received signal strength indication received from the receiving device.

Additionally or alternatively, the additional network related information may comprise a signal to noise ratio received from the receiving device.

According to a third aspect of the invention there is provided a method for data rate adaptation in a wireless transmitter operating in a wireless network, the method comprising: generating data packets at progressively increasing data rates; transmitting the generated data packets; monitoring, at the wireless transmitter, a packet error rate for the transmitted data packets; observing, at the wireless transmitter, network conditions in the wireless network; determining, from the monitored packet error rate and the observed network conditions, a maximum packet error rate threshold at which the wireless network is able to operate without instability; determining a maximum data rate at which the monitored packet error rate meets the determined maximum packet error rate threshold; and generating data packets for transmission by the wireless transmitter at the determined maximum data rate.

The method may further comprise: monitoring at the wireless transmitter, a packet error rate for transmitted data packets generated at the determined maximum data rate; and if the monitored packet error rate meets a first excessive packet error rate threshold, reducing the data rate used to generate data packets for transmission by the wireless transmitter.

The method may further comprise: if the monitored packet error rate meets the first excessive packet error rate threshold, reducing the packet size of the data packets generated for transmission by the wireless transmitter.

The first excessive packet error rate threshold may be, for example, greater than the maximum packet error rate threshold.

The method may further comprise: monitoring at the wireless transmitter, a packet error rate for transmitted data packets generated at the determined maximum data rate; and if the monitored packet error rate meets a second excessive packet error rate threshold, further reducing the data rate used to generate data packets for transmission by the wireless transmitter.

The method may further comprise: if the monitored packet error rate meets the second excessive packet error rate threshold, further reducing the packet size of the data packets generated for transmission by the wireless transmitter.

The second excessive packet error rate threshold may be, for example, greater than the first excessive packet error rate threshold.

According to a further aspect of the invention there is provided a method for data rate adaptation in a wireless transmitter, the method comprising: generating a plurality of data packets for transmission by the wireless transmitter; commencing transmission of the generated data packets; measuring a time period between generation of a data packet and transmission of that data packet; and if the measured time period between generation of a data packet and transmission of that data packet meets a threshold, adjusting a data rate at which data packets for transmission are generated.

According to a further aspect of the invention there is provided a method for detecting a change in a wireless network environment, the method comprising: generating a plurality of data packets for transmission by a wireless transmitter; defining a time window within which a predetermined number of the generated data packets are to be transmitted; commencing transmission of the generated data packets; at the end of the time window, measuring how many of the predetermined number of the generated data packets have not been transmitted; and if the measured number of the generated data packets meets a predetermined threshold, generating an indicator that a change has occurred in the wireless network environment.

According to a further aspect of the invention there is provided a method for detecting a change in a wireless network environment, the method comprising:

generating a plurality of data packets for transmission by a wireless transmitter;

commencing transmission of the generated data packets; measuring a time period between generation of a data packet and transmission of that data packet; and if the measured time period between generation of a data packet and transmission of that data packet meets a threshold, generating an indicator that a change has occurred in the wireless network environment.

The method may further comprise, in response to generating the indicator that a change has occurred in the wireless network environment, performing an estimate of the available bandwidth of the wireless network environment.

According to a further aspect of the invention there is provided a method for estimating a packet error rate (PER) experienced by an access point transmitting in a wireless network, the method comprising: determining a number of dropped packets in a downlink from the access point; determining a proportion of packets received from the access point that were re-transmissions of failed packets at the MAC layer; and estimating the PER based on the determined number of dropped packets and the determined proportion of re-transmissions of failed packets at the MAC layer.

The proportion of packets received from the access point that were re-transmissions of failed packets at the MAC layer may be determined by the access point.

Alternatively, the number of dropped packets and the proportion of packets received from the access point that were re-transmissions of failed packets at the MAC layer may be determined by a transmitter which transmits packets to the access point.

According to a further aspect of the invention there is provided a method for predicting behaviour of an access point transmitting in a wireless network, the method comprising: generating an estimate of a Packet Error Rate (PER) experienced by the access point; deriving one or more metrics relating to the performance of the wireless network; and based on the PER estimate and the one or more metrics related to the performance of the wireless network, estimating the data transmission rate of a modulation and coding scheme of the access point.

The one or more metrics may include one or more metrics selected from the group containing: the mean, median or peak transmission of a transmitter operating in the wireless network; occupancy of the wireless network; and number of corrupted packets received.

According to a further aspect of the invention there is provided a method for predicting behaviour of an access point transmitting in a wireless network, the method comprising: generating an estimate of a Packet Error Rate (PER) experienced by the access point; estimating the data transmission rate of a modulation and coding scheme (MCS) of the access point, and based on the generated PER estimate and the estimated data transmission rate of the MCS of the access point, generating an estimate of the available bandwidth of the wireless network.

According to a further aspect of the invention there is provided a wireless transmitter comprising hardware configured to perform the method of any of the above-described aspects.

According to a further aspect of the invention there is provided computer program code which, when executed by appropriate processing hardware, performs the method of any of the above-described aspects.

### BRIEF DESCRIPTION OF THE DRAWINGS

Embodiments of the invention will now be described, strictly by way of example only, with reference to the accompanying drawings, of which:

FIG. 1 is a schematic representation of an exemplary wireless network environment;

FIG. 2 is a schematic representation of an alternative wireless network environment;

FIG. 3 is a schematic representation of a WiFi® medium access control (MAC) layer message;

FIG. 4 is a schematic representation of a system that may be employed in a wireless transmitter for adapting a data rate used by the transmitter to generate data for transmission;

FIG. 5 is a schematic representation of a further system that may be employed in a wireless transmitter for adapting the data rate used by the transmitter to generate data for transmission; and

FIG. 6 is a schematic diagram showing the use of an access point model to influence the data rate at which data packets are generated for transmission by a wireless transmitter.

### DESCRIPTION OF THE EMBODIMENTS

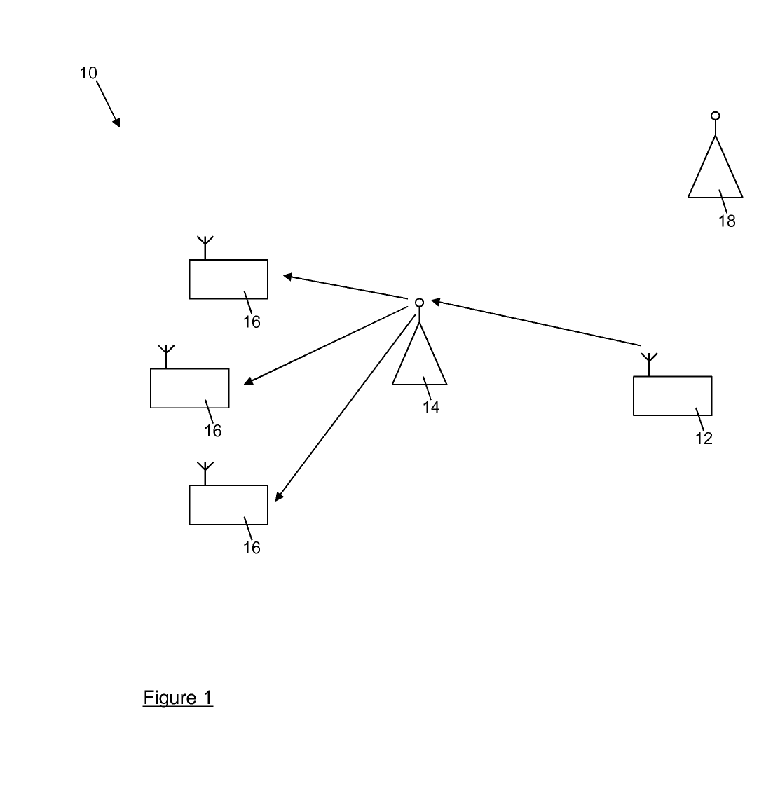

Referring first to FIG. 1, an exemplary wireless network environment, which may be, for example, a WiFi® network, is shown generally at 10. In this environment a source node 12 generates data packets such Real-time Transport Protocol (RTP) packets containing video or audio content to be streamed wirelessly, via a wireless access point 14, to a plurality of receiving devices 16. On receiving the streamed content the receiving devices 16 respond to the source node 12 with secondary information such as Acknowledge messages and Receiver's Reports. The network environment may contain more than one source node (e.g. a second source node 18 may be present) streaming media to multiple receiving devices. Thus, in the wireless network environment 10 there may be multiple source nodes each transmitting a large amount of data onto the network.

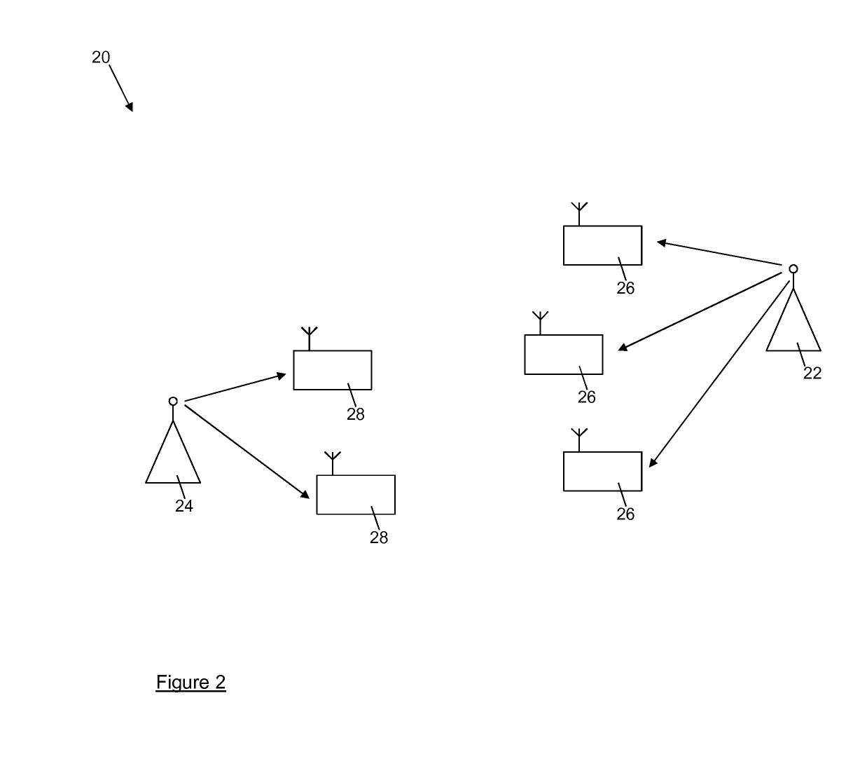

An alternative wireless network environment, which again may be a WiFi® network, for example, is shown schematically at 20 in FIG. 2. In this environment, high-bandwidth content such as RTP packets containing video or audio is streamed wirelessly to a first set of receiving devices 26 by a first wireless access point 22. A second wireless access point 24 wirelessly streams high-bandwidth content to a second set of receiving devices 28. In this example the first and second access points 22, 24 are physically far enough apart that they do not directly affect each other, but packet collisions between packets transmitted by the first and second access points 22, 24 can occur, leading to packets not being received by the receiving devices 26, 28.

As discussed above, in situations of the kind illustrated in FIG. 1, in which there may be multiple devices transmitting high-bandwidth content onto the network, packet collisions and other network conditions such as multipath fading can cause an increase in the packet error rate (PER) perceived by the transmitting devices (e.g. source nodes 12, 18 in the environment 10 of FIG. 1). The increased PER can lead the access point to reduce its transmission rate, which can lead to an increase in the time taken to transmit a stream of data, and therefore an increase in occupancy of the network by the access point, thereby reducing the available network bandwidth, potentially leading to network instability, pinching of the available bandwidth, and increased latency in the network.

To illustrate this problem, the table below illustrates the transmission times and occupancy for a 1500 byte packet of a 600 kbps stream at different data transmission rates of a wireless access point.

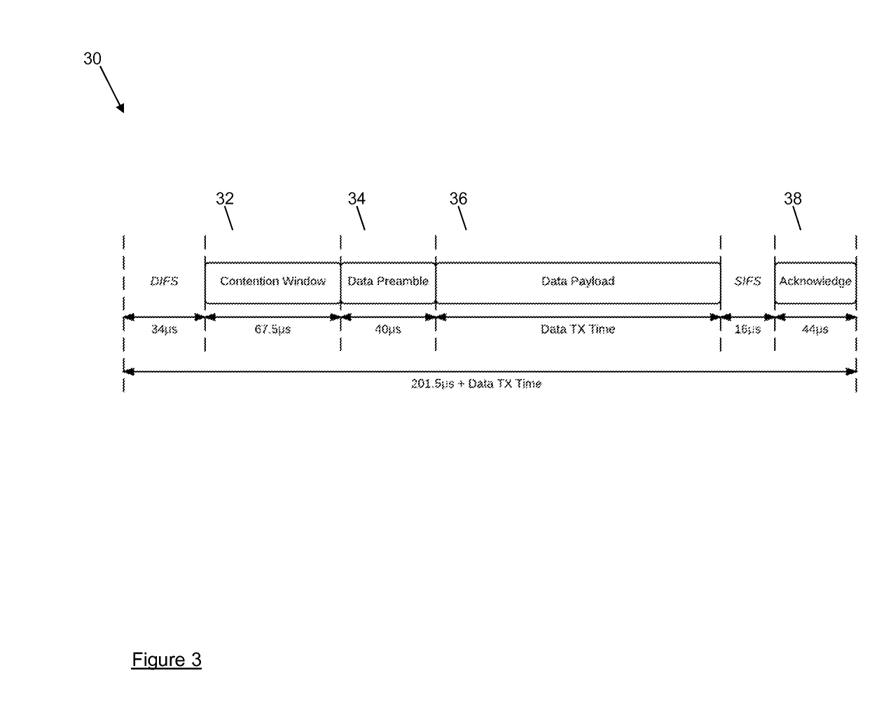

As can be seen from FIG. 3, which schematically illustrates an IEEE 802.11 MAC (medium access control) layer message, the MAC layer message 30 includes a contention window 32, a preamble 34, data 36 and an acknowledge 38. In this scenario, the overhead of the non-data part of the MAC layer message takes about 201.5 μs to transmit onto the network (calculated by summing the transmission times of the contention window, preamble and acknowledge segments and interframe spaces) depending upon the modulation and coding scheme (MCS) used by the access point.

| | Packet | Packet | |
|---|---|---|---|
| Transmission | transmission | transmission | |
| data | time | time | Occupancy for a |
| rate of | excluding | including | 600 kbps data |
| the AP | overhead | overhead | stream |
| 1 Mbps | 12 ms | 12.2 ms | 61% or 610 ms |
| 19 Mbps | 0.63 ms | 0.83 ms | 4.2% or 41.5 ms |
| 54 Mbps | 0.2 ms | 0.4 ms | 2% or 20 ms |
| 600 Mbps | 0.02 ms | 0.2 ms | 1% or 10 ms |

The table above illustrates that as the transmission rate decreases, the time taken to transmit the MAC layer message, and therefore the network occupancy, increases. In this situation occupancy refers to the portion of time taken to transmit the data stream per unit time. Occupancy can be further defined as the portion of the total available bandwidth that is occupied by the stream. For the table above, occupancy has been calculated according to the formula:

Occupancy (%)=(Rs/Rap)×(Tp2/Tp1),

Where:
Rs=data rate of the data stream;
Rap=Transmission rate of the AP;
Tp1=Time to transmit one packet, excluding overhead; and
Tp2=Time to transmit one packet, including overhead.

This problem is compounded by the way access points respond to failure of packets to be received at the receiving devices. Each packet transmitted by an access point is acknowledged at the MAC layer when it is received by a receiving device. If the access point does not receive an Acknowledgement for a packet within a predetermined period of time, it will attempt to re-send the packet, at progressively lower transmission rates, until either an Acknowledgement of the packet is received or a threshold for a maximum number of re-send attempts is reached. Typically there will be a maximum of seven to fifteen re-send attempts before a packet is dropped (i.e. the access point stops trying to re-send it). The next packet in the queue will not be transmitted until the current packet is either acknowledged or dropped. Each attempt to re-send an unacknowledged packet will consume network bandwidth. For example, assuming that three streams of audio at 600 kbps are being streamed by the source node 12 in the wireless network environment of FIG. 1 to a destination device 16 via the access point 14 (giving six hops) at 19 MBps, with an average of three re-send attempts, the occupancy would be 4.2%×6 hops×3 retries=75.6%. At this occupancy there is very little bandwidth available for any other traffic on the network.

It will be appreciated from the foregoing that, in a wireless network environment of the type illustrated in FIG. 1 or FIG. 2, in which there may be more than one source node transmitting high-bandwidth data (e.g. music or video) onto the network, the selection by the access points 14, 22, 24 of progressively lower data transmission rates in response to increasing PER can lead to increased network occupancy and to increased transmission time, which in turn leads to increased risk of packet collision. Moreover, as the transmission rates are adjusted by the access points 14, 22, 24 in response to changing PER, network instability and bandwidth pinching can arise, resulting in significantly increased latency.

The techniques discussed below aim to address these problems.

In one technique, the data rate used by a wireless transmitter (e.g. the source node 12/22 in the wireless network environment of FIG. 1) to generate data packets to be transmitted is adapted or adjusted based on the number of data packets that cannot be transmitted by the transmitter at a currently selected data rate, as will now be described with reference to the exemplary wireless network environment 10 illustrated in FIG. 1.

Initially the source node 12 streams data such as music or video in the form of data packets (e.g. RTP packets) to the access point 14, at the highest data rate possible given the available network bandwidth, for onward transmission by the access point 14 to the receiving devices 16. The packets are transmitted by the source node 12 in sequence, and the next packet in the transmit queue will not be transmitted by the source node 12 until either the current packet has been acknowledged by the access point 14 or dropped due to a threshold for the maximum number of re-send attempts being received. Thus, where an Acknowledgement is not received for a current packet, transmission of the next packet in the transmit queue will be delayed.

The source node 12 monitors the number of packets that cannot be transmitted in a predetermined time window (because of transmission delays arising from the need to await either receipt of an acknowledgement for the current packet or the time taken to reach the maximum re-send attempt threshold), and adjusts the data rate used by the transmitter to generate data packets for future transmission, to ensure optimum transmission in the prevailing network conditions.

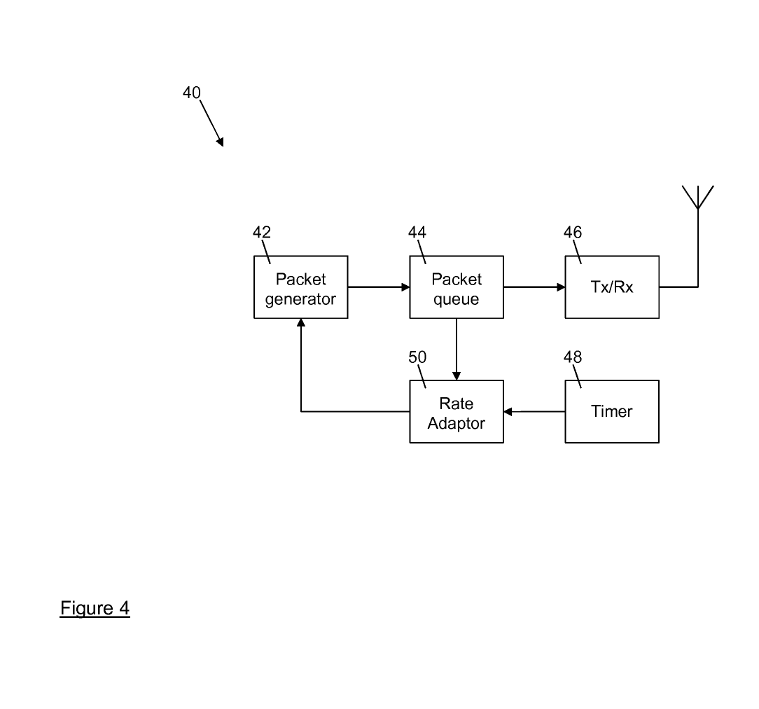

FIG. 4 is a schematic representation of a system 40 that may be employed in the source node 12 to implement this technique.

As can be seen, the system 40 includes a packet generator 42, which generates data packets, e.g. RTP packets containing encoded audio or video data to be transmitted wirelessly to a remote receiving device. The packet generator 42 may comprise a single codec (encoder-decoder) capable of generating encoded data at different data rates, or may comprise a plurality of different codecs which each generate encoded data at a different data rate. The packet generator 42 includes a control input by means of which the rate at which data packets are generated and encoded by the packet generator 42 can be adjusted, e.g. by causing the packet generator 42 to change the data rate of the codec, or, where appropriate, to select a different one of the plurality of codecs.

The packet generator 42 outputs generated packets to a packet queue 44, where the packets are queued for transmission by a wireless transmit/receive stage 46.

The wireless transmit/receive stage 46 transmits the packets in turn. As indicated above, the next packet in the packet queue 44 is not transmitted until either a MAC layer Acknowledgement for the currently transmitted packet has been received, or the current packet is dropped as a result of a threshold for the maximum number of re-send attempts being reached.

A timer 48 is also provided, to measure a predetermined time period. The timer 48 outputs a signal to a rate adaptor 50 at the end of the predetermined time period. When it receives this signal from the timer 48, the rate adaptor 50 inspects the packet queue 44, to determine the number of un-transmitted packets in the packet queue 42. If the number of un-transmitted packets in the packet queue 42 at the end of the predetermined time period meets a predetermined threshold, the rate adaptor 50 outputs a signal to the packet generator 42, to adjust the rate at which data packets are generated for transmission. The packet generator 42 then generates a new set of packets for transmission at the new rate.

As an example, the packet generator 42 may initially be configured to generate 50 packets per second, and the system 50 may be configured to transmit five packets at the beginning of a 100 ms window. Within 100 ms of generating the packets, all five of the packets should have been transmitted, meaning that at the end of the 100 ms window (i.e. the predetermined period measured by the timer 48 is 100 ms) there should be no packets left in the packet queue 44. If any packets remain in the packet queue 44 at the end of the 100 ms window, it can be deduced that the wireless link from the source node 12 to the access point 14 is incapable of supporting the initial data rate of the data stream generated by the packet generator 42. Thus, a signal is output by the rate adaptor 50 to the packet generator 42, to adjust the rate at which data packets are generated for transmission, e.g. by causing the packet generator 42 to change the data rate of the codec, or, where appropriate, to select an alternative one of the plurality of codecs having a lower data rate.

The reduction in the packet generation rate may be dependent upon the number of un-transmitted packets remaining in the packet queue at the end of the predetermined time period. For example, if only one packet remains in the packet queue at the end of the time window, only a small reduction in the packet generation rate may be required, whereas if four or five packets remain un-transmitted in the packet queue 44 at the end of the time window then a greater reduction in the packet generation rate may be required. Thus, the number of un-transmitted packets remaining in the packet queue at the end of the time window may be compared to multiple different thresholds to determine the rate at which the data packets are generated by the packet generator 42 for transmission.

This technique allows the source node 12 (or other wireless transmitter) rapidly to detect changes in the wireless network environment, for example caused by another transmitter of high-bandwidth data, or other factors such as activation of a microwave oven in the vicinity of the network environment, and to adapt its data generation rate accordingly, to reduce the likelihood of packet loss and packet delay.

The ability of the system 40 to measure a fast drop in the available network bandwidth, and therefore the ability to take mitigating action, is dependent upon the size of the time window. The smaller the time window, the greater the likelihood that jitter in the transmitting system (e.g. OS Scheduler) will be mistaken for changes in the network environment, whilst the larger the time window the slower a disruption in the network environment will be detected using this technique.

An alternative approach is to measure, using the timer 48, the time between generation of a packet and transmission of that packet. If the time between generation and transmission of a packet reaches a predetermined threshold, this may indicate that the wireless link from the source node 12 to the access point 14 is incapable of supporting the initial data rate of the data stream generated by the packet generator 42. Thus, a signal is output by the rate adaptor 50 to the packet generator 42, to adjust the rate at which data packets are generated for transmission, e.g. by causing the packet generator 42 to change the data rate of the codec, or, where appropriate, to select an alternative one of the plurality of codecs having a lower data rate.

The above-described techniques, which may be used with an unreliable protocol such as UDP (User Datagram Protocol) allow the system 40 quickly to detect a change in the available bandwidth in the network environment.

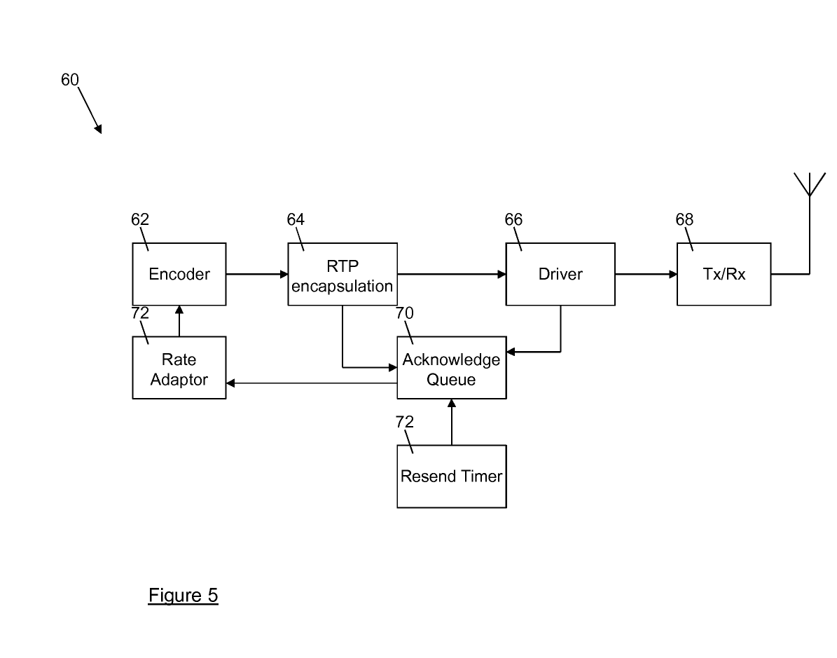

A further technique that can be used to reduce the risk of network instability and bandwidth pinching in a wireless network such as an IEEE 802.11 network of the kind illustrated in FIGS. 1 and 2 will now be described with reference to FIG. 5. This technique may be used in isolation or in combination with the techniques described above.

FIG. 5 is a schematic representation of a system that may be employed in the source node 12 to implement this technique.

The system 60 illustrated in FIG. 5 implements an acknowledgement and retry mechanism at the application level of a wireless transmitter such as the source node 12. It is to be noted that this application level acknowledgement and retry mechanism is in addition to the acknowledgement mechanism employed in the MAC layer.

The system 60 includes an encoder 62 which encodes content such as audio or video data into data packets. An RTP encapsulator 64 adds an RTP header including an RTP sequence number to each data packets output by the encoder 62, before the encapsulated packets are passed on to a driver 66 for transmission to the destination devices via a transmit/receive stage 68.

The system 60 also includes an application level acknowledge queue 70, where encapsulated packets are stored until an acknowledgement is received from a receiving device, and a resend timer 72, which governs the retransmission of packets that have not been acknowledged by a receiving device. Thus, when an encapsulated packet is passed to the driver 66 for transmission to the destination device, a copy of that encapsulated packet is placed in the application level acknowledge queue 70.

In response to receiving an RTP packet transmitted by a transmitting device such as a source node using the system 60, a receiving device transmits an application layer Acknowledge packet to the transmitting device. Information associated with or derived from application layer Acknowledge packets received by the system 60 can be used to adjust the data rate used by the system 60 to generate data packets for transmission, to optimise transmission for the prevailing network environment conditions, as will be explained below. To this end, the system 60 also includes a rate adaptor 72, which is operative to output a signal to the encoder 62 to adjust the rate at which data packets for future transmission are generated.

Typically, packets will be received by the receiving devices in order, and thus the application layer Acknowledge packets transmitted by the receiving devices will also be received by the source node in order. Thus, if an application layer Acknowledge packet for a particular packet is received by the system 60 before an application layer Acknowledge packet for a preceding packet, this might be indicative that the preceding packet has been dropped (i.e. not received by the receiving device). If all of the MAC layer re-send attempts for that packet have been exhausted then there has been a larger number of packet drops, which may result in the transmission rate used by the access point being reduced, potentially leading to pinching of the available network bandwidth as discussed above. In order to reduce the risk of such pinching, the rate adaptor 72 may act to reduce the data rate at which data packets for future transmission are generated by the encoder 62, for example by changing the data rate of the codec, or, where appropriate, causing the encoder to select an alternative codec having a lower data rate.

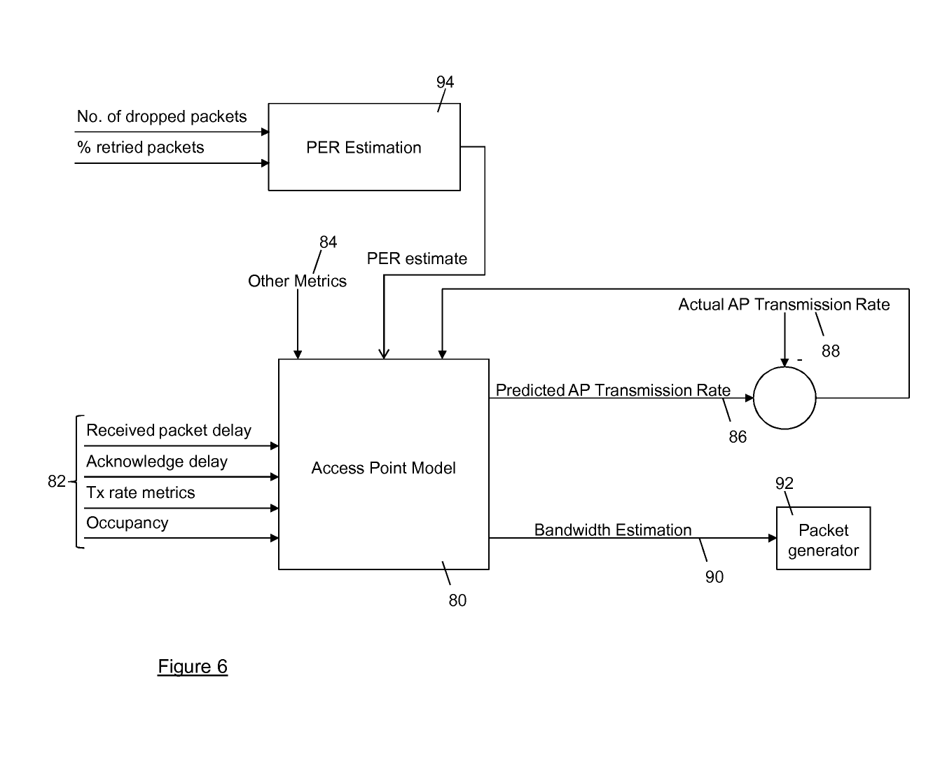

The application layer Acknowledge packets contain additional information that can be used to develop a model of an access point in a wireless network environment, as will now be described with reference to FIG. 6, which is a schematic diagram showing the use of an access point model to influence the data rate at which data packets are generated for transmission by a wireless transmitter.

The access point model 80 is a learning algorithm that receives as inputs various metrics 82 returned in or associated with the application level Acknowledge packets sent by a receiving device (e.g. receiving devices 16) which receives a data stream from a source node (e.g. source node 12) via an access point (e.g. access point 14) to the source node in response to the data stream.

The metrics 82 returned in the application layer Acknowledge packets by the receiving device, or associated with the application layer Acknowledge packets, may include, for example, the following:
Received packet delay;
Application layer Acknowledge packet delay;
Median, mean and peak transmission rate of the transmitting device and of the receiving device;
Number of received corrupted packets;
   Occupancy; and
   Number or proportion of retries.

The median, mean and peak transmission rate of the transmitting device and of the receiving device, occupancy and number of retries metrics may alternatively (or additionally) be collated at the transmitter side and used to estimate the bandwidth of the system.

These metrics will be described in more detail below.

The RTP sequence numbers of the received RTP packets are included in the application layer Acknowledge packet transmitted by the receiving device. When this Acknowledge packet is received by the system 60, packets in the application level acknowledge queue 70 whose RTP sequence numbers correspond to the RTP sequence numbers contained in the received Acknowledge packet are removed from the application level acknowledge queue 70.

RTP packets are typically generated every 10 to 100 ms by the RTP encapsulator 64, whilst each device receiving a stream of RTP packets will generate an application layer Acknowledge packet every 100 ms. Each application layer Acknowledge packet refers to any new packets received by the receiving device since the last application layer Acknowledge packet transmitted by that device. This means that the time between transmission of an RTP packet by the system 60 and receipt by the system 60 of the application layer Acknowledge packet from the receiving device for that packet should be less than 300 ms, taking into account the round-trip delay of the wireless network.

The time taken for an application layer Acknowledge packet for a particular RTP packet transmitted by the system 60 to be received can be monitored (e.g. by the transmission rate adaptor 72) to derive an application layer Acknowledge packet delay metric, by comparing the time at which the relevant encapsulated packet is placed in the application level acknowledge queue 70 and the time at which that packet is removed from the application level acknowledge queue because an application layer Acknowledge packet has been received, to the expected time for receipt of the application layer Acknowledge packet. This metric, a measure of the difference between the expected time for transmitted packets to be acknowledged by a receiving device and the actual time taken for transmitted packets to be acknowledged by the receiving device can be used as a measure of the latency in the wireless network. An increase in latency may indicate that a change in the data rate used to generate data packets for transmission onto the network may be desirable.

As the transmitted RTP packets are much larger than the application layer Acknowledge packets, the RTP packets are much more likely to be adversely affected by disruption in the network environment, and to a larger degree, than the application layer Acknowledge packets. A large difference between the expected time for acknowledgement of transmitted packets and the actual time for acknowledgement of transmitted packets may be indicative of high latency, for example. Moreover, changes in this difference may be indicative of changes in the network latency. A sharp increase in latency can indicate a disruption in the network environment. In response, a change in the in the data rate used to generate data packets for transmission onto the network may be desirable.

The median, mean and peak transmission rate of the transmitting device and of the receiving device directly represent the transmission rates in the wireless network environment. If these rates are lower than expected then the network conditions may be unfavourable, indicating that a change in the data rate for generation of data packets for future transmission may be desirable.

The number of received corrupted packets represents the number of packets that were received by a receiving device but could not be processed because of a checksum mismatch. If this metric differs from an expected value, this can indicate a deterioration in network conditions which may necessitate a change in the data rate for generation of data packets for future transmission.

Occupancy is a measure of the proportion of time that a transmission medium is in use and gives an indication of the spare capacity available. If this metric changes suddenly this can indicate that network conditions have changed and that a change (decrease or increase) in the data rate for generation of data packets for future transmission may be appropriate. For example if this metric meets or exceeds a first predefined threshold then occupancy may be increasing, indicating that the available bandwidth is reducing and a decrease in the data rate may be required. On the other hand, if this metric falls below a second predefined threshold (which may be different from the first threshold) then occupancy may be decreasing, indicating that more bandwidth is available and an increase in the data for generation of data packets for future transmission may be possible.

The IEEE 802.11 MAC header contains a flag which indicates that the received packet was not the first attempt to transmit the packet (i.e. that the data packet received by the receiving device was a re-transmission of a data packet at the MAC layer that was previously not successfully received by the receiving device). The receiving device can use this information to evaluate or estimate the PER in the downlink from the transmitting device, for example by counting the number of these flags that are present in received data packets over a predetermined time, and can return this information (the estimated PER or the raw numerical data) to the transmitting device in the Acknowledge packet. If this metric differs from an expected value, this can indicate a change in network conditions which may necessitate a change in the data rate for generation of data packets for future transmission.

As previously indicated, each data packet transmitted by a transmitting device is acknowledged at the MAC layer when it is received by a receiving device. If the transmitting device does not receive an Acknowledgement for a packet within a predetermined period of time, it will repeatedly attempt to re-send the packet until either an Acknowledgement of the packet is received or a threshold for a maximum number of re-send attempts is reached. Typically there will be a maximum of seven to fifteen re-send attempts before a packet is dropped.

The transmitting device records the number of re-send attempts for each packet to generate a number of re-sends metric. This can be divided by the total number of transmitted data packets to derive a proportion of re-sends metric indicating the proportion of the transmitted data packets that were re-transmissions of failed packets at the MAC layer. A high number or proportion of re-send attempts may be an indication of a change in network conditions which may necessitate a change in the data rate for generation of data packets for future transmission.

Other metrics 84 such as RSSI and SNR values are returned to the source node less frequently, in Receiver's Reports transmitted by the receiving device to the source node.

The RSSI and SNR measure the signal strength between the transmitting device and a receiving device. If either of these metrics differs from an expected value, this can indicate a deterioration in network conditions which may necessitate a change in the data rate for generation of data packets for future transmission.

Some or all of the metrics discussed above are input to the access point model 80, which processes the received metrics according to predefined rules and calculates a prediction 86 of the transmission rate used by the access point (e.g. the data transmission rate of a modulation and coding scheme (MCS) used by the access point). This prediction 86 can be compared with the actual transmission rate 88 achieved by the access point (which is also reported to the source node in the Receiver's Reports), and the prediction can be further refined.

A bandwidth estimate 90 can be generated based on the refined transmission rate prediction, and this bandwidth estimate 90 can be used to adjust the rate at which data packets to be transmitted onto the network are generated by a packet generator 92 such as an audio/video codec, to increase, decrease or maintain, as appropriate, the rate of generation of data for transmission onto the network.

The number of dropped packets and the proportion of retried packets metrics, as determined either at the receive side (e.g. at an access point) or at the transmit side (e.g. by a source node which transmits data packets to an access point) may be passed separately to a packet error rate estimator 94, which is configured to generate, from the number of dropped packets and the proportion of retried packets metrics, an estimate of the packet error rate in the downlink from the transmitting device.

This PER estimate can be passed to the access point model 80 and used in the generation of the bandwidth estimate 90 and the access point transmission rate estimate 86.

Alternatively, the number of dropped packets and the proportion of retried packets metrics may be passed directly to the access point model 80, which performs the PER estimation.

As will be appreciated from the foregoing discussion, information associated with or derived from the application level Acknowledge messages received at the application level of a wireless transmitter such as a source node 12 can be used to determine whether an adjustment to the data rate for generation of data packets for future transmission is necessary or desirable to optimise the data rate for prevailing conditions in the wireless network environment.

The present disclosure also extends to a method for maintaining a data rate for generation of data packets for transmission by a wireless transmitter (e.g. source node 12) to an access point (e.g. access point 14) at a level that can be supported by the access point in the prevailing network conditions without causing instability in the network, as will now be described with reference to FIG. 5.

The data rate at which data packets are generated by the encoder 62 for transmission by the wireless transmitter is increased progressively to a level at which packet errors are observed at the application level. These packet errors may be indicated by changes in the metrics reported in or associated with the application layer Acknowledge messages discussed above, for example. Increasing the data rate further may result in the wireless network becoming unstable and pinching of the network bandwidth.

As the data rate at which data packets are generated by the encoder 62 increases, the transmitting device measures the packet error rate as indicated by the various metrics returned in or derived from the application layer Acknowledge packets, and makes observations as to the stability of the network and available bandwidth. For example, in experiments it was observed that a PER of 4 per second at the application level could be tolerated without instability or pinching of bandwidth.

In operation of the system 60, the transmitting device monitors the PER at the application level (for example using the metrics returned in or derived from the application layer Acknowledge packets, as discussed above) and acts to prevent instability and bandwidth pinching as the PER observed at the application layer increases.

For example, an application level PER threshold may be set (in the experiment discussed above the PER threshold is 4 per second, for example), and the transmitting device may take action if this PER threshold is met or exceeded. Additionally or alternatively, a threshold for the proportion of MAC layer retries may be set, and the transmitting device may take action if this MAC later retry proportion threshold is met or exceeded.

For example, if the PER observed at the application level rises to a level greater than the PER threshold, e.g. twice the PER threshold, the rate adaptor 72 may be operative to reduce the data rate of data packets generated for transmission by the encoder 62. Additionally, the encoder 62 may be operative to generate data packets with a smaller packet size. In this way, the system 60 can proactively act to reduce the risk of collision in the wireless network. If the PER observed at the application increases to an even greater level, e.g. three times the PER threshold, the rate adaptor 72 further reduces the data rate at which data packets are generated for transmission, and the encoder 62 further reduces the packet size of the data packets being generated. In this way the network is afforded space to recover from any instability or pinching that may have occurred, and the risk of packet collision is reduced.

It will be appreciated that the techniques described above can be used alone or in combination to more intelligently select the data rate used for generation of data packets for transmission by a wireless transmitter operating in a wireless environment of the kind illustrated in FIGS. 1 and 2, to optimise the data rate for the prevailing network conditions.

Further, the techniques described above can be adapted to detect changing conditions in a wireless network environment, and to indicate that the available network bandwidth needs to be re-estimated, and/or to estimate the packet error rate (PER) that an access point operating in a wireless network environment may experience, and/or to predict the behaviour of an access point operating in a wireless network environment.

It will be appreciated that the techniques described above can be implemented in hardware or as software running on appropriate processing hardware.

1. A method for data rate adaptation in a wireless transmitter, the method comprising:
generating a plurality of data packets for transmission by the wireless transmitter;
defining a time window within which a predetermined number of the generated data packets are to be transmitted;
commencing transmission of the generated data packets;
at the end of the time window, measuring how many of the predetermined number of the generated data packets have not been transmitted; and
adjusting a data rate at which data packets for transmission are generated based on the measured number of un-transmitted data packets.

2. A method according to claim 1 wherein the generated data packets are stored in a transmission queue.

3. A method according to claim 2 wherein the number of un-transmitted packets remaining in the transmission queue is measured at the end of the time window.

4. A method according to claim 1 wherein adjusting the data rate at which data packets for transmission are generated based on the measured number of un-transmitted packets comprises comparing the number of un-transmitted packets to a threshold and reducing the data rate if the measured number of un-transmitted packets meets the threshold.

5. A method according to claim 4 wherein adjusting the data rate at which data packets are generated for transmission based on the measured number of un-transmitted packets comprises comparing the number of un-transmitted packets to a plurality of different thresholds and reducing the data rate according to a threshold of the plurality of thresholds that is met by the number of un-transmitted packets.

6. A method for data rate adaptation in a wireless transmitter, the method comprising:
generating a plurality of data packets for transmission by the wireless transmitter;
transmitting each of the plurality of data packets in turn;
receiving at the wireless transmitter an application layer acknowledgement from a receiving device that a data packet has been received; and
based on information associated with the application layer acknowledgement, adjusting the data rate at which data packets are generated for transmission by the wireless transmitter.

7. A method according to claim 6, the method further comprising:
storing each transmitted data packet in an application level acknowledge queue at the wireless transmitter; and
removing a transmitted data packet from the application level acknowledge queue when an application layer acknowledgement of that data packet has been received by the wireless transmitter from a receiving device.

8. A method according to claim 6, further comprising:
measuring a difference between an expected time of receipt by the wireless transmitter of an application layer acknowledgement for a particular transmitted data packet and an actual time of receipt of the application layer acknowledgement for the particular transmitted data packet; and
based on the measured difference between the expected time of receipt and the actual time of receipt, adjusting the data rate for generation of data packets for transmission by the wireless transmitter.

9. A method according to claim 6, wherein the information associated with the application layer acknowledgement comprises an indication contained in the application layer acknowledgement of the proportion of the data packets received by the receiving device that were re-transmissions at the MAC layer of data packets that was previously not successfully received by the receiving device.

10. A method according to claim 6 wherein the information associated with the application layer acknowledgement comprises one or more of: the mean transmission rate; the median transmission rate; and the peak transmission rate of the transmitter or the receiving device.

11. A method according to claim 6 wherein the information associated with the application layer acknowledgement comprises an indication from the receiving device of the number of corrupted packets received by the receiving device.

12. A method according to claim 6 wherein the information associated with the application layer acknowledgement comprises an indication of network occupancy.

13. A method according to claim 6 further comprising:
receiving additional network related information from the receiving device; and
based on the information associated with the application layer acknowledgement and the additional network related information, adjusting the data rate at which data packets are generated for transmission by the wireless transmitter.

14. A method according to claim 13 wherein the additional network related information comprises a received signal strength indication received from the receiving device.

15. A method according to claim 13 wherein the additional network related information comprises a signal to noise ratio received from the receiving device.

16. A method for data rate adaptation in a wireless transmitter operating in a wireless network, the method comprising:
generating data packets at progressively increasing data rates;
transmitting the generated data packets;
monitoring, at the wireless transmitter, a packet error rate for the transmitted data packets;
observing, at the wireless transmitter, network conditions in the wireless network;
determining, from the monitored packet error rate and the observed network conditions, a maximum packet error rate threshold at which the wireless network is able to operate without instability;
determining a maximum data rate at which the monitored packet error rate meets the determined maximum packet error rate threshold; and
generating data packets for transmission by the wireless transmitter at the determined maximum data rate.

17. A method according to claim 16 further comprising:
monitoring at the wireless transmitter, a packet error rate for transmitted data packets generated at the determined maximum data rate; and
if the monitored packet error rate meets a first excessive packet error rate threshold, reducing the data rate used to generate data packets for transmission by the wireless transmitter.

18. A method according to claim 17 further comprising:
if the monitored packet error rate meets the first excessive packet error rate threshold, reducing the packet size of the data packets generated for transmission by the wireless transmitter.

19. A method according to claim 17 wherein the first excessive packet error rate threshold is greater than the maximum packet error rate threshold.

20. A method according to claim 17 further comprising:
monitoring at the wireless transmitter, a packet error rate for transmitted data packets generated at the determined maximum data rate; and
if the monitored packet error rate meets a second excessive packet error rate threshold, further reducing the data rate used to generate data packets for transmission by the wireless transmitter.

21. A method according to claim 20 further comprising:
if the monitored packet error rate meets the second excessive packet error rate threshold, further reducing the packet size of the data packets generated for transmission by the wireless transmitter.

22. A method according to claim 20 wherein the second packet error rate threshold is greater than the first packet error rate threshold.

23. A method for data rate adaptation in a wireless transmitter, the method comprising:
generating a plurality of data packets for transmission by the wireless transmitter;
commencing transmission of the generated data packets;
measuring a time period between generation of a data packet and transmission of that data packet; and
if the measured time period between generation of a data packet and transmission of that data packet meets a threshold, adjusting a data rate at which data packets for transmission are generated.

24. A method for detecting a change in a wireless network environment, the method comprising:
generating a plurality of data packets for transmission by a wireless transmitter;
defining a time window within which a predetermined number of the generated data packets are to be transmitted;
commencing transmission of the generated data packets;
at the end of the time window, measuring how many of the predetermined number of the generated data packets have not been transmitted; and
if the measured number of the generated data packets meets a predetermined threshold, generating an indicator that a change has occurred in the wireless network environment.

25. A method for detecting a change in a wireless network environment, the method comprising:
generating a plurality of data packets for transmission by a wireless transmitter;
commencing transmission of the generated data packets;
measuring a time period between generation of a data packet and transmission of that data packet; and
if the measured time period between generation of a data packet and transmission of that data packet meets a threshold, generating an indicator that a change has occurred in the wireless network environment.

26. A method according to claim 24 further comprising, in response to generating the indicator that a change has occurred in the wireless network environment, performing an estimate of the available bandwidth of the wireless network environment.

27. A method for estimating a packet error rate (PER) experienced by an access point transmitting in a wireless network, the method comprising:
determining a number of dropped packets in a downlink from the access point;
determining a proportion of packets received from the access point that were re-transmissions of failed packets at the MAC layer; and
estimating the PER based on the determined number of dropped packets and the determined proportion of re-transmissions of failed packets at the MAC layer.

28. A method according to claim 27 wherein the number of dropped packets and the proportion of packets received from the access point that were re-transmissions of failed packets at the MAC layer are determined by the access point.

29. A method according to claim 27 wherein the number of dropped packets and the proportion of packets received from the access point that were re-transmissions of failed packets at the MAC layer are determined by a transmitter which transmits packets to the access point.

30. A method for predicting behaviour of an access point transmitting in a wireless network, the method comprising:
generating an estimate of a Packet Error Rate (PER) experienced by the access point;
deriving one or more metrics relating to the performance of the wireless network; and
based on the PER estimate and the one or more metrics related to the performance of the wireless network, estimating the data transmission rate of a modulation and coding scheme of the access point.

31. A method according to claim 30 wherein the one or more metrics include one or more metrics selected from the group containing: the mean, median or peak transmission of a transmitter operating in the wireless network; occupancy of the wireless network; and number of corrupted packets received.

32. A method for predicting behaviour of an access point transmitting in a wireless network, the method comprising:
generating an estimate of a Packet Error Rate (PER) experienced by the access point;
estimating the data transmission rate of a modulation and coding scheme (MCS) of the access point, and
based on the generated PER estimate and the estimated data transmission rate of the MCS of the access point, generating an estimate of the available bandwidth of the wireless network.

33. A wireless transmitter comprising hardware configured to perform the method of claim 1.

34. A wireless transmitter comprising hardware configured to perform the method of claim 6.

35. A wireless transmitter comprising hardware configured to perform the method of claim 16.

36. A wireless transmitter comprising hardware configured to perform the method of claim 23.

37. A wireless transmitter comprising hardware configured to perform the method of claim 24.

38. A wireless transmitter comprising hardware configured to perform the method of claim 25.

39. A wireless transmitter comprising hardware configured to perform the method of claim 27.

40. A wireless transmitter comprising hardware configured to perform the method of claim 30.

41. A wireless transmitter comprising hardware configured to perform the method of claim 32.

42. Computer program code which, when executed by appropriate processing hardware, performs the method of claim 1.

43. Computer program code which, when executed by appropriate processing hardware, performs the method of claim 6.

44. Computer program code which, when executed by appropriate processing hardware, performs the method of claim 16.

45. Computer program code which, when executed by appropriate processing hardware, performs the method of claim 23.

46. Computer program code which, when executed by appropriate processing hardware, performs the method of claim 24.

47. Computer program code which, when executed by appropriate processing hardware, performs the method of claim 25.

48. Computer program code which, when executed by appropriate processing hardware, performs the method of claim 27.

49. Computer program code which, when executed by appropriate processing hardware, performs the method of claim 30.

50. Computer program code which, when executed by appropriate processing hardware, performs the method of claim 32.
